(19) United States
(12) Patent Application Publication
(10) Pub. No.: US 2024/0250766 A1
(43) Pub. Date: Jul. 25, 2024

(54) METHOD OF PERFORMANCE MONITORING FOR CSI PREDICTION

(71) Applicants: Viktor Sergeev, Lucan (IE); Bishwarup Mondal, San Ramon, CA (US); Avik Sengupta, San Jose, CA (US); Utthara Shankar, MILPITAS, CA (US); Dong Han, San Jose, CA (US)

(72) Inventors: Viktor Sergeev, Lucan (IE); Bishwarup Mondal, San Ramon, CA (US); Avik Sengupta, San Jose, CA (US); Utthara Shankar, MILPITAS, CA (US); Dong Han, San Jose, CA (US)

(21) Appl. No.: 18/628,042

(22) Filed: Apr. 5, 2024

Related U.S. Application Data
(60) Provisional application No. 63/494,965, filed on Apr. 7, 2023.

(51) Int. Cl. H04B 17/391; H04W 24/10

(52) U.S. Cl. CPC H04B 17/3913; H04W 24/10

(57) ABSTRACT

An apparatus and system are described for measurement and reporting of Channel State Information (CSI) prediction performance. A user equipment (UE) receives Channel State Information (CSI) Reference Signals (CSI-RS) from a 5^{th} generation NodeB (gNB) at different time instances and performs perform channel measurements on the CSI-RS. The UE calculates a predicted CSI for a later time instance based on the CSI-RS and subsequently performs a channel measurement based on a CSI-RS received in the later time instance. The UE calculates an actual CSI based on the CSI-RS received in the later time instance. determines metrics based on a comparison between the predicted CSI and the actual CSI, and transmits the metrics to the gNB.

### PRIORITY CLAIM

This application claims the benefit of priority to U.S. Provisional Patent Application Ser. No. 63/494,965, filed Apr. 7, 2023, which is incorporated herein by reference in its entirety.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such the complexity of such communication systems has increased. As expected, a number of issues abound with the advent of any new system, including complexities related to Channel State Information (CSI) measurements.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some aspects.

FIG. 3 illustrates a schematic representation of a CSI report without channel prediction in accordance with some aspects.

FIG. 4 illustrates a schematic representation of a CSI report with channel prediction in accordance with some aspects.

FIG. 5 illustrates a schematic representation of a CSI prediction performance M calculation in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

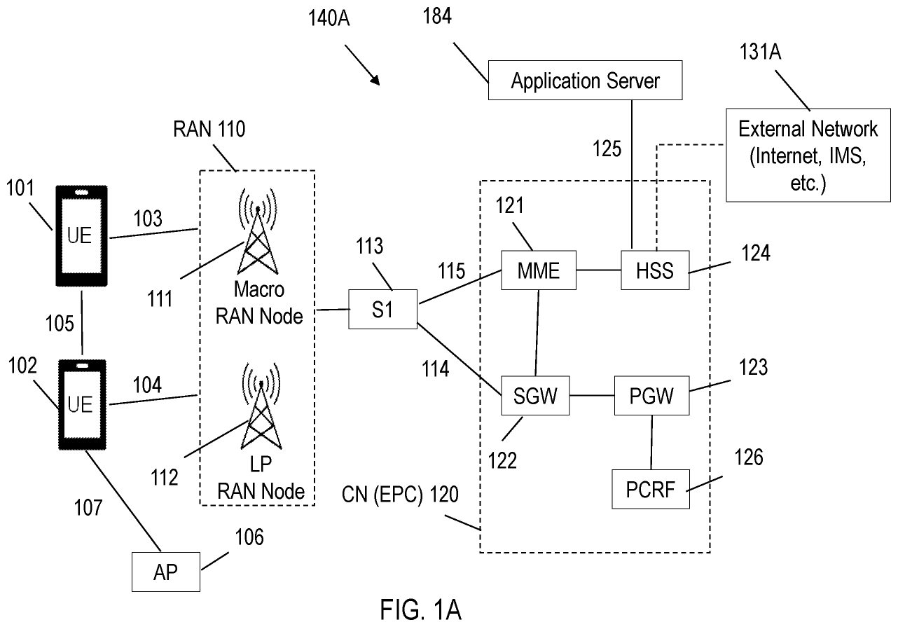

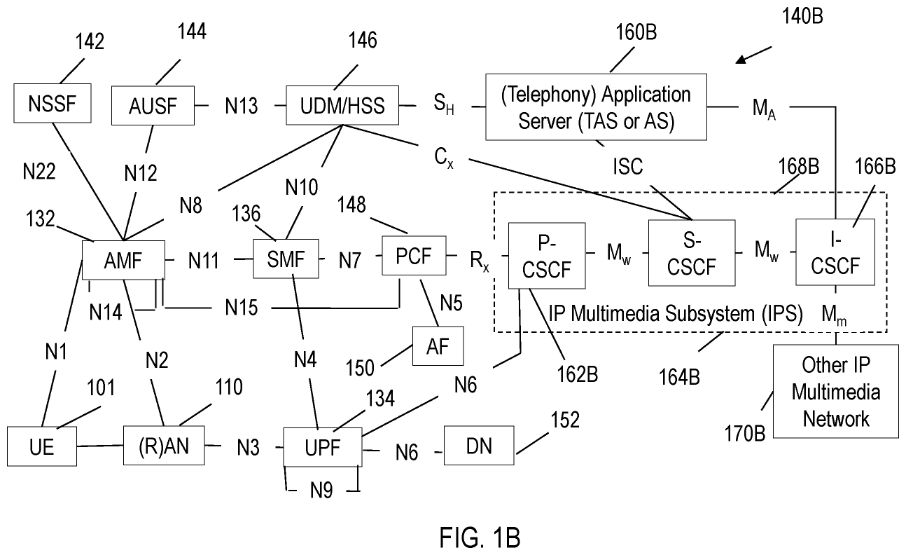

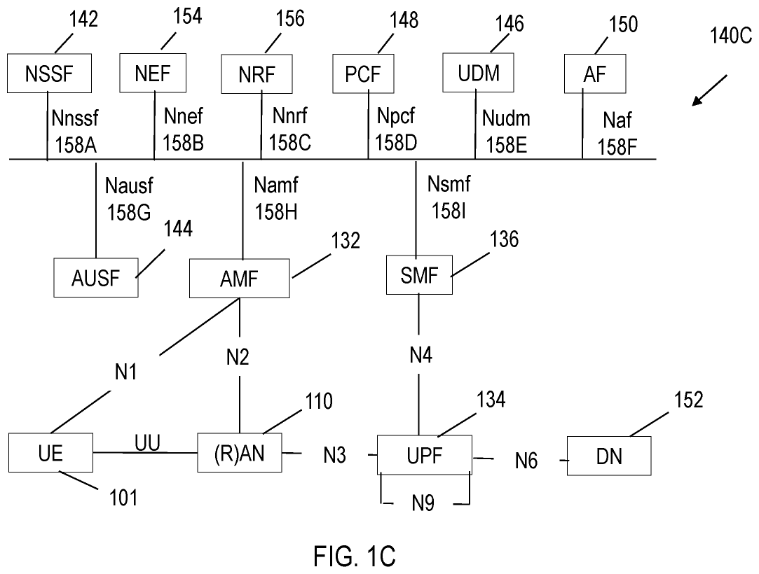

FIG. 1A illustrates an architecture of a network in accordance with some aspects. The network 140A includes 3GPP Long Term Evolution (LTE), 4^{th} generation (4G) and 5^{th} generation (5G) (or next generation (NG)) network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IOT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IOT (eNB-IOT) UE and Further Enhanced (FeNB-IOT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a UMTS protocol, a 3GPP LTE protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), 5^{th} Generation NodeBs (gNBs), RAN nodes, and the like, and can comprise ground stations (e.g., terrestrial access points) or satellite access nodes (SANs) providing coverage within a geographic area (e.g., a cell) and/or non-terrestrial networks. In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node. Accordingly, the term gNB is used as a shorthand to refer to any type of RAN node capable of providing the functionality described herein.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IOT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

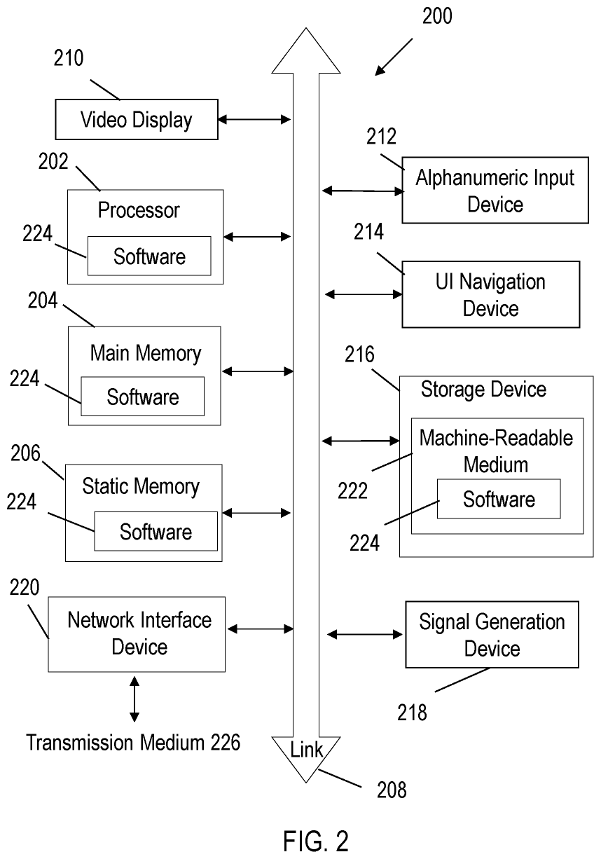

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as IEEE 802.11 family of standards known as Wi-Fi, IEEE 802.16 family of standards known as WiMax, IEEE 802.15.4 family of standards, an LTE family of standards, a UMTS family of standards, peer-to-peer (P2P) networks, a 5G standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology, for example UMTS, Freedom of Multimedia Access (FOMA), 3GPP LTE, 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), UMTS (3G), Wideband Code Division Multiple Access (UMTS) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), TD-CDMA, Time Division-Synchronous Code Division Multiple Access, 3rd Generation Partnership Project Release 8 (Pre-4^{th} Generation) (3GPP Rel. 8 (Pre-4G)), and subsequent Releases (such as Rel. 9-19, etc.), 3GPP 5G, 5G, 5G New Radio (5G NR), 3GPP 5G New Radio, 3GPP NR NTN (Non-terrestrial NTN), 3GPP LTE Extra, LTE-Advanced Pro, LTE Licensed-Assisted Access (LAA), MuLTEfire, UMTS Terrestrial Radio Access (UTRA), E-UTRA, LTE Advanced (4G), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), PTT, Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, Dedicated Short Range Communications (DSRC) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHZ), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHZ and further frequencies and SAS=Spectrum Access System/CBRS=Citizen Broadband Radio System in 3.55-3.7 GHZ and further frequencies). Applicable spectrum bands include International Mobile Telecommunications spectrum as well as other types of spectrum/bands, such as bands with national allocation (including 450-470 MHz, 902-928 MHZ (note: allocated for example in US (FCC Part 15)), 814-894 MHZ (note: 3GPP band n26), 703-803 MHz (note: 3GPP band n28), 698-746 MHZ (note: lower 700 MHz spectrum in US, 3GPP band n85), 874-925 MHZ (note: 3GPP band n100), 450-470 MHz (note: 3GPP bands n31, n72), 863-868.6 MHZ (note: allocated for example in European Union (ETSI EN 300 220)), 915.9-929.7 MHz (note: allocated for example in Japan), 917-923.5 MHZ (note: allocated for example in South Korea), 755-779 MHz and 779-787 MHz (note: allocated for example in China), 790-960 MHZ, 1710-2025 MHz, 2110-2200 MHz, 2300-2400 MHz, 2.4-2.4835 GHZ (note: it is an ISM band with global availability and it is used by Wi-Fi technology family (11b/g/n/ax) and also by Bluetooth), 2500-2690 MHZ, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHz, 31-31.3 GHZ, 37-38.6 GHZ, 38.6-40 GHz, 42-42.5 GHZ, 57-64 GHz, 71-76 GHZ, 81-86 GHz and 92-94 GHz, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHZ), WiGig Band 2 (59.40-61.56 GHZ) and WiGig Band 3 (61.56-63.72 GHZ) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as Program Making and Special Events (PMSE), medical, health, surgery, automotive, low-latency, drones, etc. applications.

As above, CSI measurements are used to improve performance of Physical Downlink Shared Channel (PDSCH) transmission in 5G NR cellular communication systems. CSI feedback can be used to derive the CSI; the UE measures the channel and interference (CSI measurements) based on CSI Reference Signals (CSI-RS) and CSI Interference Measurements (CSI-IM) respectively, calculates the CSI based on the CSI measurements, and reports the CSI to the gNB.

If a UE has a high or medium velocity, PDSCH performance degradation is expected due to CSI aging since the CSI report is applied for PDSCH transmission with certain delay from the corresponding CSI measurements. In such cases, channel prediction can be used to improve the PDSCH performance.

For CSI prediction at the UE side, the CSI contains information about one or multiple time instances after the CSI measurements. The exact CSI prediction algorithm is up to the UE implementation and may not be known at the gNB. The performance of CSI prediction depends on many factors (e.g., UE speed, channel angular spread, Doppler spread etc.) that are not known at the gNB. Thus, the prediction performance is not known at the gNB and, in some cases, a CSI without prediction may perform better than a CSI with prediction.

Accordingly, methods of CSI prediction performance monitoring are described herein that allow measurement of CSI prediction performance and reports the measurement to the gNB so that gNB can optimize usage of the CSI report and provide a proper CSI configuration.

### Channel State Information Feedback

Channel state information (CSI) feedback is used in LTE and 5G NR systems to assist scheduling, link adaptation, precoding, and spatial multiplexing operations for downlink (DL) transmission. The CSI report is transmitted from the UE to the gNB via a physical uplink control channel (PUCCH) or a physical uplink shared channel (PUSCH) in an Uplink Control Information (UCI) message.

There are three main components of the CSI report:
The Channel Quality Indicator (CQI) contains information on the modulation and coding scheme (MCS) recommended by the UE for DL transmission;
The Rank Indicator (RI) contains information on the number of spatial layers (rank) recommended by the UE for DL transmission;
The Precoding Matrix Indicator (PMI) contains information on the precoding matrix recommended by the UE for DL transmission. The rank of the precoding matrix is determined by the RI.

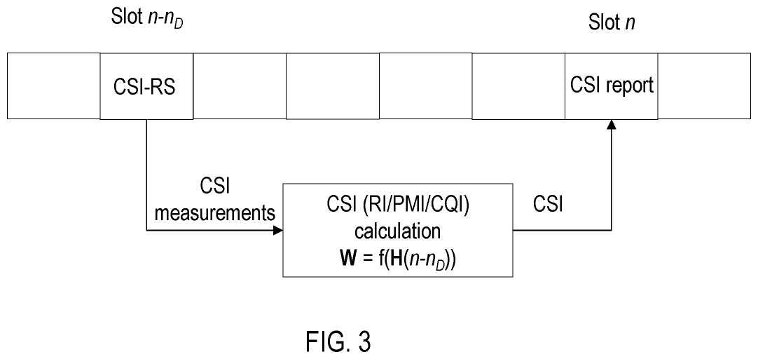

The PMI, RI and CQI are calculated at the UE based on the CSI-RS and CSI-IM used for channel and interference measurements respectively. The RI and PMI search can be represented by the following mathematical operation: W=f(H(n)), where W is the precoding matrix corresponding to the selected RI and PMI, H(n) is the channel matrix corresponding to slot n, f( ) is the RI and PMI search function. Without CSI prediction, slot n corresponds to the slot of CSI measurements as is represented in FIG. 3, which illustrates a schematic representation of a CSI report without channel prediction in accordance with some aspects.

Herein, the channel matrix can correspond to a matrix that is based on the channel matrix or channel measurements (e.g., Singular Value Decomposition (SVD) vectors of the channel matrix or channel covariance matrix or channel matrix for physical resource block or frequency subband). The channel matrix and precoding matrix may have two or three or more dimensions. The first dimension of the channel matrix is N_{Rx} or RI, the second dimension of the channel matrix is N_{P} or L. The first dimension of the precoding matrix is N_{P} or L, the second dimension of the precoding matrix is N_{Rx} or RI. N_{Rx} is the number of UE receive antennas, N_{P} is the number of CSI-RS ports, L is the number of basis vectors configured by the gNB. Other dimensions of the channel matrix may include frequency dimension (PRBs, subbands, delay etc.), time dimension (slots, time instances, time units, Doppler unit, etc.), etc.

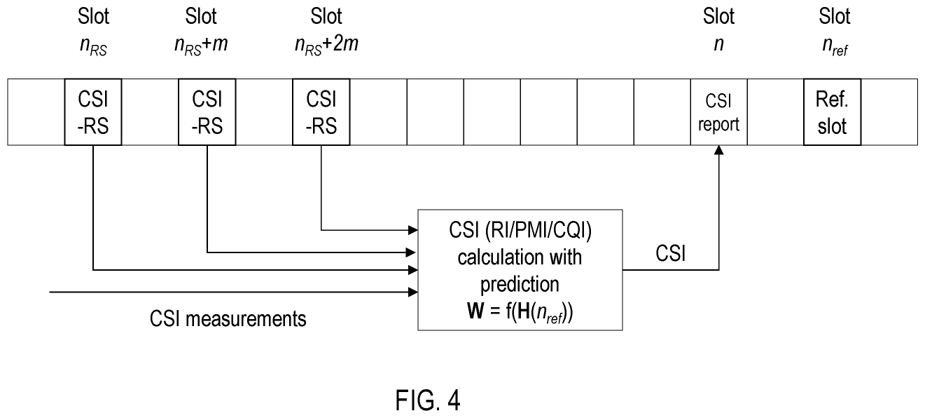

If CSI prediction is performed, channel measurements may be performed in multiple time instances corresponding to multiple CSI-RS occasions or multiple CSI-RS resources. In this case, the RI and PMI search is performed based on the channel matrix predicted by the UE for a reference slot n_{ref}. This is shown in FIG. 4, which illustrates a schematic representation of a CSI report with channel prediction in accordance with some aspects.

### Channel Prediction

A prediction implementation may rely on a model of channel evolution in time. For example, it can be assumed that an element of the channel matrix corresponds to a linear combination of complex exponents with frequencies f(k) as parameters, which is shown in equation (1). Alternatively, an autoregressive model may be used, where it is assumed that an element of the channel matrix is a linear combination of previous channel measurements with autoregression parameters a(k), which is shown in equation (2).

$$s ( l ) = {\sum }_{k = 1}^{p} c ( k ) \cdot exp ( j \cdot f ( k ) \cdot l ) , \\ s ( l ) = {\sum }_{k = 1}^{p} c ( k ) \cdot exp ( j \cdot f ( k ) \cdot l ) , \qquad ( 1 )$$

$$s ( l ) = {\sum }_{k = 1}^{o} \{ a ( k ) \cdot s ( l - k ) \} + n ( l ) \qquad ( 2 )$$

For equation (1) and (2), l is an index of time instance, s(l) is an element of the channel matrix, p is the number of complex exponents, c(k) is the linear combination coefficient, f(k) is the frequency (Doppler frequency), a(k) are autoregression parameters, o is the order of the autoregression model, n(l) is additive white Gaussian noise.

Channel prediction may also be performed using an Artificial Intelligence/Machine Learning model (AI/ML) model.

In general case, it can be assumed that prediction of the channel matrix H(t) is performed for a time instance t by using multiple channel matrixes {H(t₁), H(t₂), H(t₃), . . . , H(t_{I})} measured in multiple time instances tₗ (l={1, 2, . . . , I}), H(t)=p(H(t₁), H(t₂), H(t₃), . . . , H(t_{I}), P), where p( ) corresponds to the prediction function and P corresponds to the parameters of the prediction function which are trained based on previous channel measurements and/or a dataset, I—number of CSI-RS instances used for prediction. For example, P may correspond to f(k) in equation (1) or a(k) in equation (2) or parameters (weights) of a neural network for the Artificial Intelligence/Machine Learning model, etc.

### CSI Prediction Performance Measurement

In one embodiment, CSI prediction performance is measured by applying channel prediction for a time instance tₙ corresponding to CSI measurements instance equation (3).

$${H}_{p} ( {t}_{n} ) = p ( H ( {t}_{1} ) , H ( {t}_{2} ) , … , H ( {t}_{I} ) , P ) \qquad ( 3 )$$

In one embodiment, performance metrics M is calculated based on the measured channel in the time instance tₙ H(tₙ) and the predicted channel Hₚ(tₙ) such that M=g(H(tₙ), Hₚ(tₙ)), where g( ) is a function for performance metrics calculation.

In another embodiment, the performance metrics M is calculated based on the measured channel in the time instance tₘ, H(tₘ) and the predicted channel Hₚ(tₙ) such that M=g(H(tₘ), Hₚ(tₙ)).

In one option, the performance metrics M correspond to the mean square error (MSE), normalized mean square error (NMSE), generalized cosine similarity (GCS), or square generalized cosine similarity (SGCS). Examples of NMSE, GCS, and SGCS correspond to equation (4), (5), and (6) respectively.

$$M = {‖ {H}_{p} ( {t}_{n} ) - H ( {t}_{n} ) ‖}^{2} / {‖ H ( {t}_{n} ) ‖}^{2} \qquad ( 4 )$$

$$M = ‖ {H}_{p} ( {t}_{n} ) \cdot {( H ( {t}_{n} ) )}^{H} ‖ / \{ ‖ H ( {t}_{n} ) ‖ \cdot ‖ {H}_{p} ( {t}_{n} ) ‖ \} \qquad ( 5 )$$

If M is complex-valued, the real value or absolute value may be taken as a measure of CSI prediction performance.

If the channel matrix H has three or more dimensions, the average value of M calculated per each two-dimensional matrix that corresponds to the first two dimensions of the channel matrix and may be taken as a measure of CSI prediction performance.

If the channel matrix H is defined for multiple time units N₄, M may be reported per each time unit.

In another embodiment, the performance metrics M is calculated based on precoding matrix W=f(H(tₙ)) and Wₚ=f(Hₚ(n)), M=g(W(tₙ), Wₚ(tₙ)).

In another embodiment, M is the ratio (or other function) of metrics corresponding to the CSI without prediction M₁ and metrics corresponding to the CSI with prediction M₂. For example, M₁=g(H(tₙ), Hₚ(tₙ)) and M₂=g(H(tₘ), H(tₙ)). For example, M is a ratio between M₁ and M₂.

In another embodiment, M is calculated separately per UE receive antenna or separately per layer.

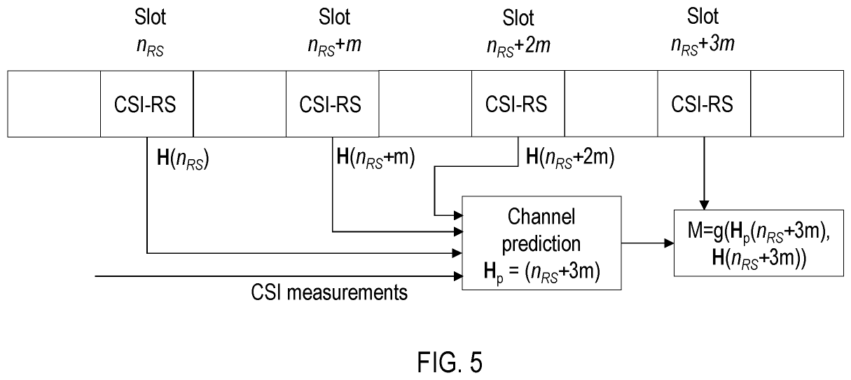

FIG. 5 illustrates a schematic representation of a CSI prediction performance M calculation in accordance with some aspects.

### CSI Prediction Performance Reporting

In one embodiment, the CSI prediction performance M is quantized, normalized (if desired), and reported by the UE in the CSI report together with the RI/PMI/CQI or in a separate (dedicated) CSI report.

In other embodiment, the UE reports one bit or multiple bits (bitfield) B that indicates the CSI prediction performance.

In other embodiment, each bit in B corresponds to the result of a comparison of the CSI prediction performance metrics M with a threshold(s) T (i.e., whether M is greater or less than T). The threshold(s) T may be configured via higher layers.

In other embodiment, the bit in B corresponds to the result of a comparison of the CSI prediction performance M₁ and the CSI performance without prediction M₂.

In one embodiment, depending on the CSI prediction performance, the UE may report the CSI, including the PMI, CQI, RI, with or without prediction.

### Training Weights

The performance of the CSI prediction depends on the number of measured time instances with the CSI-RS. If the number is too low, the performance of the CSI prediction may be unacceptable. Hence, information on the minimum number of CSI-RS instances/resources at the UE may be reported by the UE.

In one embodiment, the minimum number of time instances with a CSI-RS and/or minimum distance between the CSI-RS instances/resources (m) used by the UE to achieve an acceptable prediction performance is reported by the UE via UE capability reporting. Multiple values may be reported corresponding to different time gaps between the last CSI-RS instance and the reference slot for prediction.

In another embodiment, the minimum number of time instances with a CSI-RS and/or minimum distance between CSI-RS instances/resources (m) used by the UE to achieve better prediction performance is reported together with the RI/PMI/CQI in a CSI report, in a separate (dedicated) CSI report, or reported via a Medium Access Control (MAC) Control Element (CE). Multiple values may be reported corresponding to different time gaps between the last CSI-RS instance and the reference slot for prediction.

In one embodiment, the UE may use all CSI-RS occasions for training of the prediction parameters P, if timeRestrictionForChannelMeasurements is enabled and/or not configured.

### EXAMPLES

Example 1 is an apparatus for a user equipment (UE), the apparatus comprising: processing circuitry to: configure the UE to perform channel measurements based on Channel State Information (CSI) Reference Signals (CSI-RS) received from a 5th generation NodeB (gNB) at different time instances; calculate, from the CSI-RS received at the different time instances, a predicted CSI for a later time instance after the different time instances; perform a channel measurement based on a CSI-RS received in the later time instance; calculate an actual CSI based on the CSI-RS received in the later time instance; determine metrics based on a comparison between the predicted CSI and the actual CSI; and encode the metrics for transmission in a CSI report to the gNB; a memory configured to store the metrics.

In Example 2, the subject matter of Example 1 includes, wherein the processing circuitry is configured to calculate the predicted CSI using a one-sided Artificial Intelligence/Machine Learning model (AI/ML) model at the UE.

In Example 3, the subject matter of Examples 1-2 includes, wherein the metrics include at least one of mean square error (MSE), normalized mean square error (NMSE), generalized cosine similarity (GCS), or square generalized cosine similarity (SGCS).

In Example 4, the subject matter of Examples 1-3 includes, wherein: a subset of bits of the CSI report is determined based on CSI prediction performance derived based on different matrices, a first matrix of the matrices is based on CSI-RS measurements, and a second matrix of the matrices is based on a CSI prediction algorithm implemented at the UE.

In Example 5, the subject matter of Example 4 includes, wherein: the first matrix is one of a channel matrix, eigenvectors of the channel matrix, or a precoding matrix, and the second matrix corresponds to a predicted channel matrix, eigenvectors of the predicted channel matrix, or the precoding matrix.

In Example 6, the subject matter of Examples 4-5 includes, . . . , XL are matrixes that are at least one of measured or calculated based on CSI-RS in multiple time instances, P is a vector of prediction parameters, and p( ) is a prediction function.

In Example 7, the subject matter of Examples 4-6 includes, wherein the processing circuitry determines CSI prediction performance M from at least one of M=g(X, Y) or M=g(X, Y)/g(X, Xn), where Xn is a matrix at least one of measured or calculated based on CSI-RS, and g( ) is a prediction performance matrix.

In Example 8, the subject matter of Example 7 includes, wherein the processing circuitry quantizes M and encodes the CSI prediction performance M in at least one of the CSI report using the subset of bits or in a report separate from the CSI report.

In Example 9, the subject matter of Examples 7-8 includes, wherein the subset of bits corresponds to a comparison of M and T, where T is a threshold that is at least one of configured via higher layers or derived at the UE.

In Example 10, the subject matter of Examples 1-9 includes, wherein the processing circuitry determines CSI prediction performance and determines whether to use CSI prediction based on whether the CSI prediction performance at least meets a minimum threshold CSI prediction performance.

In Example 11, the subject matter of Examples 1-10 includes, wherein the processing circuitry encodes, for transmission to the gNB, UE capabilities that include at least one of a number of CSI-RS time instances used for CSI prediction or a time gap between adjacent CSI-RS time instances.

In Example 12, the subject matter of Example 11 includes, wherein the processing circuitry encodes, for transmission to the gNB, the UE capabilities in at least one of a CSI report or Medium Access Control (MAC) Control Element (CE).

In Example 13, the subject matter of Examples 1-12 includes, wherein the processing circuitry encodes, for transmission to the gNB in at least one of the CSI report, a different CSI report, or Medium Access Control (MAC) Control Element (CE), that at least one of a received number of CSI-RS time instances used for CSI prediction or a time gap between adjacent CSI-RS time instances is insufficient to achieve a minimum level of CSI prediction performance.

In Example 14, the subject matter of Examples 1-13 includes, wherein the processing circuitry uses all CSI-RS time instances for training of prediction parameters, in response a determination that a higher layer parameter timeRestrictionForChannelMeasurements is at least one of enabled or not configured.

In Example 15, the subject matter of Examples 1-14 includes, wherein the processing circuitry calculates the metrics separately at least one of per UE receive antenna or per layer.

In Example 16, the subject matter of Examples 1-15 includes, wherein the processing circuitry uses a real value or an absolute value of the metrics for complex-valued metrics.

Example 17 is an apparatus for a 5th generation NodeB (gNB), the apparatus comprising: processing circuitry to: encode, for transmission to a user equipment (UE), Channel State Information (CSI) Reference Signals (CSI-RS) at different time instances; and decode, from the UE, metrics based on a comparison between an actual CSI measured at a particular time instance and a predicted CSI, the predicted CSI determined from a combination of CSIs obtained for a predetermined number of time instances prior to the particular time instance; and a memory configured to store the metrics.

In Example 18, the subject matter of Example 17 includes, wherein the processing circuitry decode, from the UE in at least one of a CSI report or Medium Access Control (MAC) Control Element (CE), UE capabilities that include at least one of a number of CSI-RS time instances used for CSI prediction or a time gap between adjacent CSI-RS time instances.

Example 19 is a computer-readable storage medium that stores instructions for execution by one or more processors of a user equipment (UE), the one or more processors to, when the instructions are executed: configure the UE to perform channel measurements based on Channel State Information (CSI) Reference Signals (CSI-RS) received at different time instances; calculate, from the CSI-RS received in the different time instances, a predicted CSI for a later time instance after the different time instances; perform a channel measurement based on a CSI-RS received in the later time instance; calculate an actual CSI based on the CSI-RS received in the later time instance; and determine metrics based on a comparison between the predicted CSI and the actual CSI.

In Example 20, the subject matter of Example 19 includes, wherein: the one or more processors to, when the instructions are executed, calculate the predicted CSI using a one-sided Artificial Intelligence/Machine Learning model (AI/ML) model at the UE, and the metrics include at least one of mean square error (MSE), normalized mean square error (NMSE), generalized cosine similarity (GCS), or square generalized cosine similarity (SGCS).

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE), the apparatus comprising:
processing circuitry to:
configure the UE to perform channel measurements based on Channel State Information (CSI) Reference Signals (CSI-RS) received from a 5^{th} generation NodeB (gNB) at different time instances;
calculate, from the CSI-RS received at the different time instances, a predicted CSI for a later time instance after the different time instances;
perform a channel measurement based on a CSI-RS received in the later time instance;
calculate an actual CSI based on the CSI-RS received in the later time instance;
determine metrics based on a comparison between the predicted CSI and the actual CSI; and
encode the metrics for transmission in a CSI report to the gNB;
a memory configured to store the metrics.

2. The apparatus of claim 1, wherein the processing circuitry is configured to calculate the predicted CSI using a one-sided Artificial Intelligence/Machine Learning model (AI/ML) model at the UE.

3. The apparatus of claim 1, wherein the metrics include at least one of mean square error (MSE), normalized mean square error (NMSE), generalized cosine similarity (GCS), or square generalized cosine similarity (SGCS).

4. The apparatus of claim 1, wherein:
a subset of bits of the CSI report is determined based on CSI prediction performance derived based on different matrices,
a first matrix of the matrices is based on CSI-RS measurements, and
a second matrix of the matrices is based on a CSI prediction algorithm implemented at the UE.

5. The apparatus of claim 4, wherein:
the first matrix is one of a channel matrix, eigenvectors of the channel matrix, or a precoding matrix, and
the second matrix corresponds to a predicted channel matrix, eigenvectors of the predicted channel matrix, or the precoding matrix.

6. The apparatus of claim 4, wherein the CSI prediction algorithm corresponds to Y=p(X1, X2, . . . , XI, P), where X1, X2, . . . , XI are matrixes that are at least one of measured or calculated based on CSI-RS in multiple time instances, P is a vector of prediction parameters, and p( ) is a prediction function.

7. The apparatus of claim 4, wherein the processing circuitry determines CSI prediction performance M from at least one of M=g(X, Y) or M=g(X, Y)/g(X, Xn), where Xn is a matrix at least one of measured or calculated based on CSI-RS, and g( ) is a prediction performance matrix.

8. The apparatus of claim 7, wherein the processing circuitry quantizes M and encodes the CSI prediction performance M in at least one of the CSI report using the subset of bits or in a report separate from the CSI report.

9. The apparatus of claim 7, wherein the subset of bits corresponds to a comparison of M and T, where T is a threshold that is at least one of configured via higher layers or derived at the UE.

10. The apparatus of claim 1, wherein the processing circuitry determines CSI prediction performance and determines whether to use CSI prediction based on whether the CSI prediction performance at least meets a minimum threshold CSI prediction performance.

11. The apparatus of claim 1, wherein the processing circuitry encodes, for transmission to the gNB, UE capabilities that include at least one of a number of CSI-RS time instances used for CSI prediction or a time gap between adjacent CSI-RS time instances.

12. The apparatus of claim 11, wherein the processing circuitry encodes, for transmission to the gNB, the UE capabilities in at least one of a CSI report or Medium Access Control (MAC) Control Element (CE).

13. The apparatus of claim 1, wherein the processing circuitry encodes, for transmission to the gNB in at least one of the CSI report, a different CSI report, or Medium Access Control (MAC) Control Element (CE), that at least one of a received number of CSI-RS time instances used for CSI prediction or a time gap between adjacent CSI-RS time instances is insufficient to achieve a minimum level of CSI prediction performance.

14. The apparatus of claim 1, wherein the processing circuitry uses all CSI-RS time instances for training of prediction parameters, in response a determination that a higher layer parameter timeRestrictionForChannelMeasurements is at least one of enabled or not configured.

15. The apparatus of claim 1, wherein the processing circuitry calculates the metrics separately at least one of per UE receive antenna or per layer.

16. The apparatus of claim 1, wherein the processing circuitry uses a real value or an absolute value of the metrics for complex-valued metrics.

17. An apparatus for a 5^{th} generation NodeB (gNB), the apparatus comprising:
processing circuitry to:
encode, for transmission to a user equipment (UE), Channel State Information (CSI) Reference Signals (CSI-RS) at different time instances; and
decode, from the UE, metrics based on a comparison between an actual CSI measured at a particular time instance and a predicted CSI, the predicted CSI determined from a combination of CSIs obtained for a predetermined number of time instances prior to the particular time instance; and
a memory configured to store the metrics.

18. The apparatus of claim 17, wherein the processing circuitry decode, from the UE in at least one of a CSI report or Medium Access Control (MAC) Control Element (CE), UE capabilities that include at least one of a number of CSI-RS time instances used for CSI prediction or a time gap between adjacent CSI-RS time instances.

19. A computer-readable storage medium that stores instructions for execution by one or more processors of a user equipment (UE), the one or more processors to, when the instructions are executed:
configure the UE to perform channel measurements based on Channel State Information (CSI) Reference Signals (CSI-RS) received at different time instances;
calculate, from the CSI-RS received in the different time instances, a predicted CSI for a later time instance after the different time instances;
perform a channel measurement based on a CSI-RS received in the later time instance;
calculate an actual CSI based on the CSI-RS received in the later time instance; and
determine metrics based on a comparison between the predicted CSI and the actual CSI.

20. The medium of claim 19, wherein:
the one or more processors to, when the instructions are executed, calculate the predicted CSI using a one-sided Artificial Intelligence/Machine Learning model (AI/ML) model at the UE, and
the metrics include at least one of mean square error (MSE), normalized mean square error (NMSE), generalized cosine similarity (GCS), or square generalized cosine similarity (SGCS).
